(19) United States
(12) Patent Application Publication
(10) Pub. No.: US 2012/0019063 A1
(43) Pub. Date: Jan. 26, 2012

(54) COMPUTER APPARATUS

(75) Inventors: Huang-Ching Wang, Taipei City (TW); Yi-Yuan Yeh, Taipei City (TW); Kuan-Hsiang Chao, Taipei City (TW)

(73) Assignee: INVENTEC CORPORATION, Taipei City (TW)

(21) Appl. No.: 13/038,395

(22) Filed: Mar. 2, 2011

(30) Foreign Application Priority Data
Jul. 26, 2010 (TW) 99124534

(51) Int. Cl. H02J 1/00

(52) U.S. Cl. 307/18

(57) ABSTRACT

A computer apparatus includes a first power supply, a first power distribution board, a second power supply, a second power distribution board, motherboards, and a control module. The first power supply provides a first power. The first power distribution board is coupled to the first power supply to transmit the first power. The second power supply provides a second power. The second power distribution board is coupled to the second power supply to transmit the second power. Each of the motherboards generates a working state. The control module coupled to the first power distribution board, the second power distribution board, and the motherboards determines whether to generate a control signal based on the working states of the motherboards and a working state of the first power supply and/or a working state of the second power supply to enable a power throttling feature to adjust power consumption of the motherboards.

### CROSS-REFERENCE TO RELATED APPLICATION

This application claims the priority benefit of Taiwan application serial no. 99124534, filed on Jul. 26, 2010. The entirety of the above-mentioned patent application is hereby incorporated by reference herein and made a part of this specification.

### BACKGROUND OF THE INVENTION

1. Field of the Invention

The invention generally relates to a computer apparatus, and more particularly, to a computer apparatus having a power throttling feature.

2. Description of Related Art

In general, some computer apparatuses are equipped with two power supplies and four motherboards. If a rated voltage of each of the two power supplies is 1100 w, respectively, and the maximum power consumption of each of the motherboards approximately reaches 350 W, the total power consumption of the four motherboards in working states is approximately 350 W×4=1400 W. When the power is provided by the two power supplies in a normal manner, i.e. 2200 W of power is supplied by the two power supplies, the four motherboards can well function due to the sufficient power supply.

However, the power supplies may malfunction or may be damaged, such that only one of the power supplies in the computer apparatus can normally provide the motherboards with power. At this time, a power throttling feature of the computer apparatus can be activated to reduce the power consumption of the motherboards, e.g., by lowering down working frequencies of central processing units (CPUs) on the motherboards. Thereby, the motherboards can function consistently.

At this current stage, the power throttling feature can be merely set up by a user or by using hardware. In other words, regardless of the number of the working motherboards (e.g. one, two, three, or four), the power consumption of the motherboards is reduced when only one of the power supplies provides power to the computer apparatus and when the power throttling feature is activated. Nonetheless, as the number of the working motherboards does not exceed four, i.e. the maximum power consumption of the motherboards approximately reaches 350 W×3=1050 W, the power consumption of the motherboards does not exceed the rated power consumption 1100 W of one power supply. At this time, if the power throttling feature is still activated to lower down the working frequencies of the CPUs on the motherboards, performance of the computer apparatus is deteriorated. Since the computer apparatus cannot actively detect the actual condition, i.e. the computer apparatus does not have the mechanism of detecting the working states of the motherboards, whether the power provided by the power supply is sufficient or not cannot be observed. Accordingly, if the power provided by the power supply is sufficient and the power throttling feature is still enabled, the performance of the computer apparatus is negatively affected.

### SUMMARY OF THE INVENTION

The invention is directed to a computer apparatus which effectively prevents activation of a power throttling feature when power provided by power supplies is sufficient, such that favorable performance of the computer apparatus can be ensured.

In the invention, a computer apparatus including a first power supply, a first power distribution board, a second power supply, a second power distribution board, a plurality of motherboards, and a control module is provided. The first power supply provides a first power. The first power distribution board is coupled to the first power supply to transmit the first power. The second power supply provides a second power. The second power distribution board is coupled to the second power supply to transmit the second power. Each of the motherboards generates a working state, respectively. The control module is coupled to the first power distribution board, the second power distribution board, and the motherboards to determine whether to output a control signal to the motherboards based on the working states of the motherboards and a working state of the first power supply and/or a working state of the second power supply, so as to enable a power throttling feature to adjust power consumption of the motherboards.

According to an embodiment of the invention, the step of adjusting the power consumption of the motherboards includes lowering down working frequencies of CPUs on the motherboards in a normal working state.

According to an embodiment of the invention, the control module includes an AND gate, a detection and calculation unit, and an OR gate. A first input end of the AND gate is coupled to the first power distribution board, a second input end of the AND gate is coupled to the second power distribution board, and an output end of the AND gate generates a logic signal. An input end of the detection and calculation unit receives and detects the working states of the motherboards to calculate whether the power consumption of the motherboards in a normal working state exceeds rated power consumption of the first power supply and/or rated power consumption of the second power supply, and an adjustment signal is generated at an output end of the detection and calculation unit. A first input end of the OR gate is coupled to the output end of the AND gate, a second input end of the OR gate is coupled to the output end of the detection and calculation unit, and an output end of the OR gate generates the control signal.

According to an embodiment of the invention, each of the motherboards includes a south bridge chip, and the south bridge chips provide the working states of the motherboards.

According to an embodiment of the invention, when the first power supply and the second power supply normally function and the power consumption of the motherboards in a normal working state does not exceed the rated power consumption of the first power supply and the rated power consumption of the second power supply, the control module does not output the control signal to the motherboards in a normal working state. When one of the first power supply and the second power supply normally functions, the other one of the first power supply and the second power supply abnormally functions, and the rated power consumption of the motherboards in a normal working state does not exceed the rated power consumption of the first power supply or the rated power consumption of the second power supply, the control module does not output the control signal to the motherboards in a normal working state. When one of the first power supply and the second power supply normally functions, the other one of the first power supply and the second power supply abnormally functions, and the rated power consumption of the motherboards in a normal working state exceeds the rated power consumption of the first power supply or the rated power consumption of the second power supply, the control module outputs the control signal to the motherboards in a normal working state.

The control module of the invention is applied for detecting the working states of the motherboards and the working states of the power supplies and calculating the power consumption of the motherboards in a normal working state to determine whether the power consumption of the motherboards in a normal working state exceeds the rated power consumption of the power supplies. Thereby, whether to generate the control signal and provide the same to the motherboards can be determined, and the power throttling feature can be further activated to adjust the power consumption of the motherboards. As a result, when the power provided by the power supplies is sufficient, activation of the power throttling feature can be effectively prevented, such that favorable performance of the computer apparatus can be ensured.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a computer apparatus according to an embodiment of the invention.

### DESCRIPTION OF EMBODIMENTS

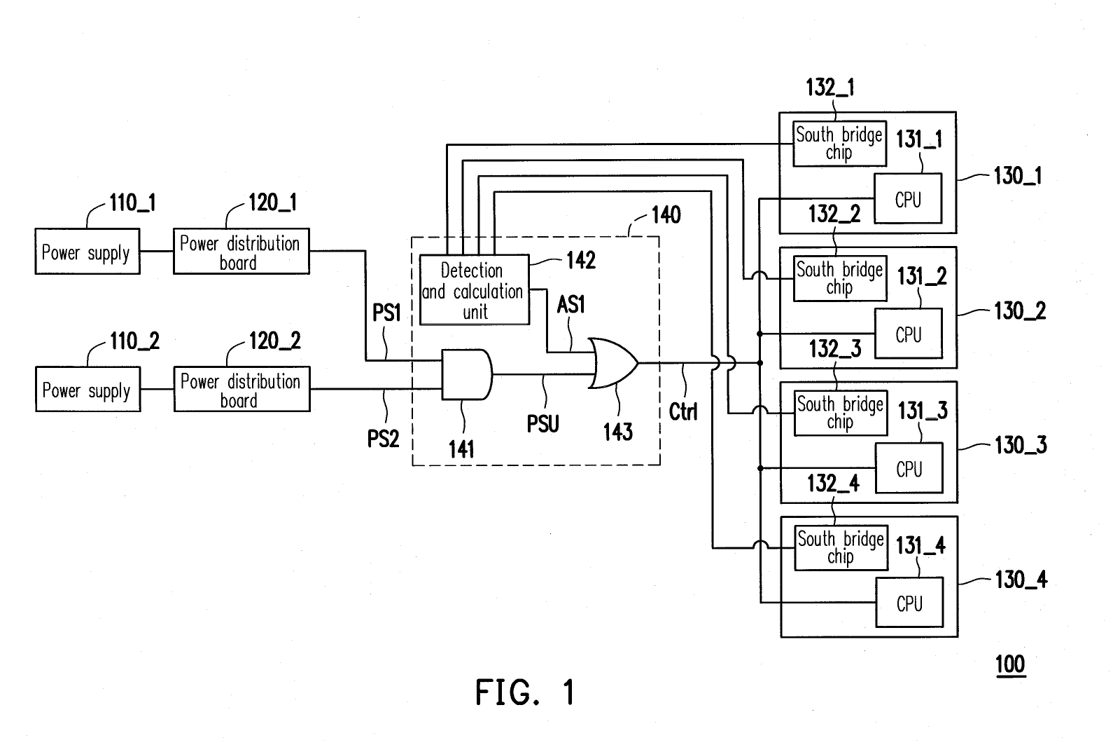

FIG. 1 is a block diagram illustrating a computer apparatus according to an embodiment of the invention. As shown in FIG. 1, a computer apparatus 100 includes power supplies 110_1 and 110_2, power distribution boards 120_1 and 120_2, motherboards 130_1, 130_2, 130_3, and 130_4, and a control module 140.

The power supplies 110_1 and 110_2 respectively provide a first power PS1 and a second power PS2. The power distribution boards 120_1 and 120_2 are respectively coupled to the power supplies 110_1 and 110_2 to transmit the first power PS1 and the second power PS2.

Each of the motherboards 130_1, 130_2, 130_3, and 130_4 includes a CPU 131_1, 131_2, 131_3, and 131_4 and a south bridge chip 132_1, 132_2, 132_3, and 132_4. In this embodiment, working states of the motherboards 130_1, 130_2, 130_3, and 130_4 are generated by the south bridge chips 132_1, 132_2, 132_3, and 132_4. For instance, when the working state of the motherboard 130_1 generated by the south bridge chip 132_1 is “H”, the motherboard 130_1 normally functions; when the working state of the motherboard 130_1 generated by the south bridge chip 132_1 is “L”, the motherboard 130_1 does not function.

The rest can be deduced from the descriptions provided above, and thus the details are omitted.

The control module 140 is coupled to the power distribution boards 120_1 and 120_2 and the motherboards 130_1, 130_2, 130_3, and 130_4 to determine whether to generate a control signal Ctrl based on the working states of the motherboards 130_1, 130_2, 130_3, and 130_4 and a working state of the power supply 110_1 and/or a working state of the power supply 110_2, so as to adjust power consumption of the motherboards 130_1, 130_2, 130_3, and 130_4.

According to this embodiment, when the power supplies 110_1 and 110_2 normally function and the power consumption of the motherboards 130_1, 130_2, 130_3, and 130_4 does not exceed the rated power consumption of the power supplies 110_1 and 110_2, the control module 140 does not output the control signal Ctrl to the motherboards 130_1, 130_2, 130_3, and 130_4. When one of the power supplies 110_1 and 110_2 normally functions, the other one of the power supplies 110_1 and 110_2 abnormally functions, and the rated power consumption of the motherboards 130_1, 130_2, 130_3, and 130_4 does not exceed the rated power consumption of the power supply 110_1 or the rated power consumption of the power supply 110_2, the control module 140 does not output the control signal Ctrl to the motherboards 130_1, 130_2, 130_3, and 130_4. When one of the power supplies 110_1 and 110_2 normally functions, the other one of the power supplies 110_1 and 110_2 abnormally functions, and the rated power consumption of the motherboards 130_1, 130_2, 130_3, and 130_4 exceeds the rated power consumption of the power supply 110_1 or the rated power consumption of the power supply 110_2, the control module 140 outputs the control signal Ctrl to the motherboards 130_1, 130_2, 130_3, and 130_4, so as to lower down working frequencies of the CPUs 131_1, 131_2, 131_3, and 131_4 on the motherboards 130_1, 130_2, 130_3, and 130_4 and to further reduce the power consumption of the motherboards 130_1, 130_2, 130_3, and 130_4.

As a result, the computer apparatus 100 of this embodiment can detect the working states of the motherboards 130_1, 130_2, 130_3, and 130_4 and thereby further determine whether the power throttling feature is activated, such that activation of the power throttling feature can be effectively prevented if the power provided by the power supplies is sufficient, and that favorable performance of the computer apparatus 100 can be ensured.

Besides, in this embodiment, the control module 140 includes an AND gate 141, a detection and calculation unit 142, and an OR gate 143. A first input end and a second input end of the AND gate 141 are respectively coupled to the power distribution boards 120_1 and 120_2, and a logic signal PSU is generated at an output end of the AND gate 141. Operation of the AND gate 141 is shown in Table 1. When the first power PS1 and the second power PS2 are both at the logic high voltage level “H”, the logic signal PSU generated at the output end of the AND gate 141 is at the logic high voltage level “H”, which indicates the power supplies 110_1 and 110_2 function in a normal manner. When the first power PS1 is at the logic high voltage level “H” and the second power PS2 is at the logic low voltage level “L”, or when the first power PS1 is at the logic low voltage level “L” and the second power PS2 is at the logic high voltage level “H”, the logic signal. PSU generated at the output end of the AND gate 141 is at the logic low voltage level “L”, which indicates that the power supply 110_1 functions in a normal manner but the power supply 110_2 functions in an abnormal manner (i.e. the power supply 110_2 does not provide power) or indicates that the power supply 110_1 functions in an abnormal manner (i.e. the power supply 110_1 does not provide power) but the power supply 110_2 functions in a normal manner.

TABLE 1
Truth table of the AND gate

| PS1 | PS2 | PSU | Notes |
|---|---|---|---|
| H | H | H | The power supplies 110_1 and 110_2 normally |
| | | | function. |
| H | L | L | The power supply 110_1 normally functions, while |
| | | | the power supply 110_2 abnormally functions. |
| L | H | L | The power supply 110_1 abnormally functions, |
| | | | while the power supply 110_2 normally functions. |

The detection and calculation unit 142 is coupled to the motherboards 130_1, 130_2, 130_3, and 130_4 to receive and detect the working states of the motherboards 130_1, 130_2, 130_3, and 130_4 and calculate whether the power consumption of the motherboards 130_1, 130_2, 130_3, and 130_4 exceeds the rated power consumption of the power supply 110_1 and/or the rated power consumption of the power supply 110_2, so as to generate an adjustment signal AS1 at the detection and calculation unit 142. For instance, when the detection and calculation unit 142 calculates and determines the power consumption of the motherboards 130_1, 130_2, 130_3, and 130_4 does not exceed the rated power consumption of the power supply 110_1 and/or the rated power consumption of the power supply 110_2, the adjustment signal AS1 output from the detection and calculation unit 142 is at the logic high voltage level “H”; when the detection and calculation unit 142 calculates and determines the power consumption of the motherboards 130_1, 130_2, 130_3, and 130_4 exceeds the rated power consumption of the power supply 110_1 and/or the rated power consumption of the power supply 110_2, the adjustment signal AS1 output from the detection and calculation unit 142 is at the logic low voltage level “L”.

A first input end of the OR gate 143 is coupled to the output end of the AND gate 141, a second input end of the OR gate 143 is coupled to the detection and calculation unit 142, and an output end of the OR gate 143 outputs the control signal Ctrl. Operation of the OR gate 143 is shown in Table 2. When the logic signal PSU is at the logic high voltage level “H” (i.e. the power supplies 110_1 and 110_2 function in a normal manner) and the adjustment signal AS1 is at the logic high voltage level “H” (i.e. the power consumption of the motherboards does not exceed the rated power consumption of the power supply 110_1 and/or the rated power consumption of the power supply 110_2), the control signal Ctrl output from the output end of the OR gate 143 is at the logic high voltage level “H”, which indicates the power throttling feature is not enabled. When the logic signal PSU is at the logic low voltage level “L” (i.e. one of the power supplies 110_1 and 110_2 is damaged) and the adjustment signal AS1 is at the logic high voltage level “H” (i.e. the power consumption of the motherboards does not exceed the rated power consumption of the power supply 110_1 and/or the rated power consumption of the power supply 110_2), the control signal Ctrl output from the output end of the OR gate 143 is at the logic high voltage level “H”, which indicates the power throttling feature is not enabled. When the logic signal PSU is at the logic low voltage level “L” (i.e. one of the power supplies 110_1 and 110_2 is damaged) and the adjustment signal AS1 is at the logic low voltage level “L” (i.e. the power consumption of the motherboards exceeds the rated power consumption of the power supply 110_1 and/or the rated power consumption of the power supply 110_2), the control signal Ctrl output from the output end of the OR gate 143 is at the logic low voltage level “L”, which indicates the power throttling feature is activated.

TABLE 2
Truth table of the OR gate

| PSU | AS1 | Ctrl | Notes |
|---|---|---|---|
| H | H | H | The two power supplies 110_1 and 110_2 normally |
| | | | function, and the power consumption of the |
| | | | motherboards does not exceed the rated power |
| | | | consumption of the power supply 110_1 and/or the |
| | | | rated power consumption of the power supply |
| | | | 110_2 |
| L | H | H | One of the two power supplies 110_1 and 110_2 is |
| | | | damaged, and the power consumption of the |
| | | | motherboards does not exceed the rated power |
| | | | consumption of the functioning one of the power |
| | | | supplies 110_1 and 110_2. |
| L | L | L | One of the two power supplies 110_1 and 110_2 is |
| | | | damaged, and the power consumption of the |
| | | | motherboards exceeds the rated power consumption |
| | | | of the functioning one of the power supplies 110_1 |
| | | | and 110_2. |

An example is provided in this embodiment to elaborate the operation of the invention. First, it is assumed that the rated power consumption of each of the two power supplies 110_1 and 110_2 is equally at approximately 1100 W, respectively, and that the power consumption of each of the motherboards 130_1, 130_2, 130_3, and 130_4 is approximately 350 W, which is not limited in this invention.

When the computer apparatus 100 is in the working state, the power supplies 110_1 and 110_2 normally function, the first power PS1 and the second power PS2 are at the logic high voltage level “H”, and the logic signal PSU generated at the AND gate 141 is at the logic high voltage level “H”. On the other hand, the detection and calculation unit 142 receives and detects the working states of the motherboards 130_1, 130_2, 130_3, and 130_4 to calculate whether the power consumption of the motherboards 130_1, 130_2, 130_3, and 130_4 exceeds the rated power consumption of the power supplies 110_1 and 110_2.

Given that the power supplies 110_1 and 110_2 normally function, no matter one motherboard (350 W of power consumption), two motherboards (350 W×2=700 W of power consumption), three motherboards (350 W×3=1050 W of power consumption), or four motherboards (350 W×4=1400 W of power consumption) in the computer apparatus 100 are working, the power consumption of the motherboards does not exceed the rated power consumption (1100 W×2=2200 W) of the power supplies 110_1 and 110_2. Hence, the detection and calculation unit 142 determines the power consumption of the motherboards does not exceed the rated power consumption of the power supplies 110_1 and 110_2, and the adjustment signal AS1 output from the detection and calculation unit 142 is at the logic high voltage level “H”. The control signal Ctrl output from the output end of the OR gate 143 to the motherboards is at the logic high voltage level “H”, which indicates the power throttling feature is not enabled. Accordingly, the computer apparatus 100 does not adjust the power consumption of the motherboards, i.e. the computer apparatus 100 does not lower down the working frequencies of CPUs on the motherboards.

In addition, when one of the power supplies 110_1 and 110_2 malfunctions or is damaged (i.e. one of the power supplies 110_1 and 110_2 normally functions and the other abnormally functions), the first power PS1 is at the logic high voltage level “H” and the second power PS2 is at the logic low voltage level “L”, or the first power PS1 is at the logic low voltage level “L” and the second power PS2 is at the logic high voltage level “H”, and the logic signal PSU generated at the AND gate 141 is at the logic low voltage level “L”. On the other hand, the detection and calculation unit 142 receives and detects the working states of the motherboards 130_1, 130_2, 130_3, and 130_4 to calculate whether the power consumption of the motherboards 130_1, 130_2, 130_3, and 130_4 exceeds the rated power consumption of the power supply 110_1 and/or the rated power consumption of the power supply 110_2.

Since one of the power supplies 110_1 and 110_2 normally functions and the other abnormally functions, the power supplied to the computer apparatus 100 is merely at 1100 W. Accordingly, when one motherboard (350 W of power consumption), two motherboards (350 W×2=700 W of power consumption), and three motherboards (350 W×3=1050 W of power consumption) in the computer apparatus 100 are working, the power consumption of the motherboards does not exceed the rated power consumption 1100 W of the power supply 110_1 or the rated power consumption 1100 W of the power supply 110_2. Hence, the detection and calculation unit 142 determines the power consumption of the motherboards does not exceed the rated power consumption of the power supply 110_1 or the rated power consumption of the power supply 110_2, and the adjustment signal AS1 output from the detection and calculation unit 142 is at the logic high voltage level “H”. The control signal Ctrl output from the output end of the OR gate 143 to the motherboards is at the logic high voltage level “H”, which indicates the power throttling feature is not enabled. Accordingly, the computer apparatus 100 does not adjust the power consumption of the motherboards, i.e. the computer apparatus 100 does not lower down the working frequencies of the CPUs on the motherboards.

Given that four motherboards (350 W×4=1400 W of power consumption) in the computer apparatus 100 are working, the power consumption of the motherboards exceeds the rated power consumption 1100 W of the power supply 110_1 or the rated power consumption 1100 W of the power supply 110_2. Hence, the detection and calculation unit 142 determines the power consumption of the motherboards exceeds the rated power consumption of the power supply 110_1 or the rated power consumption of the power supply 110_2, and the adjustment signal AS1 output from the detection and calculation unit 142 is at the logic low voltage level “L”. The control signal Ctrl output from the output end of the OR gate 143 to the motherboards is at the logic low voltage level “L”, which indicates the power throttling feature is activated. Accordingly, the computer apparatus 100 adjusts the power consumption of the motherboards, i.e. the computer apparatus 100 lowers down the working frequencies of the CPUs on the motherboards, such that the four motherboards can consistently work. As a result, in this embodiment, when the power provided by the power supplies is sufficient, activation of the power throttling feature can be effectively prevented, such that favorable performance of the computer apparatus 100 can be ensured.

In light of the foregoing, the control module described in the embodiments of the invention is applied for detecting the working states of the motherboards and the working states of the power supplies and calculating the power consumption of the motherboards in a normal working state to determine whether the power consumption of the motherboards exceeds the rated power consumption of the power supplies. Thereby, it can be further determined whether the power throttling feature is activated to adjust the power consumption of the motherboards in a normal working state (i.e. by lowering down the working frequencies of the CPUs on the motherboards). Consequently, according to the embodiments of the invention, when the power provided by the power supplies is sufficient, activation of the power throttling feature can be effectively prevented, such that favorable performance of the computer apparatus can be ensured.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A computer apparatus comprising:
a first power supply providing a first power;
a first power distribution board coupled to the first power supply to transmit the first power;
a second power supply providing a second power;
a second power distribution board coupled to the second power supply to transmit the second power;
a plurality of motherboards, each of the motherboards generating a working state; and
a control module coupled to the first power distribution board, the second power distribution board, and the motherboards to determine whether to output a control signal to the motherboards based on each of the working states of each of the motherboards and a working state of the first power supply and/or a working state of the second power supply, so as to enable a power throttling feature to adjust power consumption of the motherboards.

2. The computer apparatus as claimed in claim 1, wherein the step of adjusting the power consumption of the motherboards comprises lowering down working frequencies of central processing units on the motherboards in a normal working state.

3. The computer apparatus as claimed in claim 1, wherein the control module comprises:
an AND gate having a first input end, a second input end, and an output end, the first input end of the AND gate being coupled to the first power distribution board, the second input end of the AND gate being coupled to the second power distribution board, the output end of the AND gate generating a logic signal;
a detection and calculation unit having an input end and an output end, the input end of the detection and calculation unit receiving and detecting the working states of the motherboards to calculate whether the power consumption of the motherboards in a normal working state exceeds rated power consumption of the first power supply in the normal working state and/or rated power consumption of the second power supply in the normal working state, an adjustment signal being generated at the output end of the detection and calculation unit; and
an OR gate having a first input end, a second input end, and an output end, the first input end of the OR gate being coupled to the output end of the AND gate, the second input end of the OR gate being coupled to the output end of the detection and calculation unit, the output end of the OR gate generating the control signal.

4. The computer apparatus as claimed in claim 1, wherein each of the motherboards comprises:
a south bridge chip providing the working state of each of the motherboards.

5. The computer apparatus as claimed in claim 1, wherein when the first power supply and the second power supply normally function and the power consumption of the motherboards in a normal working state does not exceed rated power consumption of the first power supply and rated power consumption of the second power supply, the control module does not output the control signal to the motherboards in the normal working state, when one of the first power supply and the second power supply normally functions, the other one of the first power supply and the second power supply abnormally functions, and rated power consumption of the motherboards in the normal working state does not exceed the rated power consumption of the first power supply or the rated power consumption of the second power supply, the control module does not output the control signal to the motherboards in the normal working state, and when one of the first power supply and the second power supply normally functions, the other one of the first power supply and the second power supply abnormally functions, and the rated power consumption of the motherboards in the normal working state exceeds the rated power consumption of the first power supply or the rated power consumption of the second power supply, the control module outputs the control signal to the motherboards in the normal working state.
